(19) United States
(12) Patent Application Publication
(10) Pub. No.: US 2022/0022501 A1
(43) Pub. Date: Jan. 27, 2022

(54) BACON PRODUCT COMPRISING PROCESSED PORK TOPPED WITH SPICES AND METHOD FOR PREPARING SAME

(71) Applicant: CJ CHEILJEDANG CORPORATION, Jung-gu, Seoul (KR)

(72) Inventors: Woo Deok SEO, Gangseo-gu, Seoul (KR); Min Seok SONG, Paldal-gu, Suwon-si, Gyeonggi-do (KR); Cheol Won LEE, Yeongtong-gu, Suwon-si, Gyeonggi-do (KR)

(73) Assignee: CJ CHEILJEDANG CORPORATION, Jung-gu, Seoul (KR)

(21) Appl. No.: 17/277,207

(22) PCT Filed: May 28, 2019
(86) PCT No.: PCT/KR2019/006380

§ 371 Date: Mar. 17, 2021

(30) Foreign Application Priority Data
Sep. 18, 2018 (KR) 10-2018-0111644

(51) Int. Cl. A23L 13/40; A23L 13/00; A23B 4/044; B65D 81/26; A23B 4/005

(52) U.S. Cl. CPC A23L 13/428; A23L 13/03; A23V 2002/00; B65D 81/267; A23B 4/005; A23B 4/044

(57) ABSTRACT

The present invention relates to a bacon product and a method for preparing same.

### CROSS-REFERENCE TO RELATED APPLICATIONS

This application claims the priority of Korean Patent Application No. 10-2018-0111644, filed on Sep. 18, 2018, in the Korean Intellectual Property Office, the disclosure of which is incorporated herein in its entirety by reference.

### TECHNICAL FIELD

The present disclosure relates to a thick bacon product and a preparation method thereof.

### BACKGROUND ART

In general, bacon refers to food of pork which is prepared by smoking or drying after curing pork meat in salt. Bacon is sliced thinly and distributed under refrigeration or freezing condition. Since bacon can be provided with a rich meat flavor and a smoked flavor just by simple treatment, it is easy for anyone to cook bacon and the consumption and use of bacon have been on a steady increase.

As the consumption of bacon increases, bacon products treated with conventional food materials (e.g., seasonings, spices, etc.) are being developed and distributed so as to eliminate the odor peculiar to pork or to add various flavors to meet consumer preferences. However, in the case of food materials, especially those containing natural ingredients described above, it is not easy to completely remove the microorganisms that have been growing in the food materials themselves contained in the food materials. Therefore, in the case of bacon products prepared using these materials as food materials, there is a problem in that the hygiene control of the products is very difficult due to the growth of microorganisms remaining in the food materials in the environment where the products are distributed. In this regard, if possible, it will be necessary to develop a product that can improve the flavor of bacon using food materials without the risk of deterioration of hygiene.

Meanwhile, the conventional bacon products are all sliced thinly and supplied and distributed as such. Since the bacon products are thinly sliced as above, they have an advantage in that cooking can be processed rapidly. However, they have a problem in that it is difficult to realize various textures or flavors because it is not easy to retain moisture or meat juice during the cooking process, and additionally, the texture that can be felt in the process of chewing is inevitably limited. Accordingly, it is necessary to develop bacon products which can realize more various textures and flavors by avoiding the conventional stereotype that bacon products should be provided in a thin sliced form.

### DISCLOSURE OF THE INVENTION

### Technical Problem

The present disclosure intends to provide bacon products which are excellent in flavor and have a variety of textures without causing deterioration of hygiene during distribution and a preparation method thereof.

### Technical Solution

To achieve the above object, an aspect of the present disclosure provides bacon containing processed pork and spices topped on the processed pork, in which the total number of E. coli in the bacon measured after storing at a temperature of 10-15° C. for 20-36 days immediately after the preparation is less than 200 CFU/g.

Additionally, another aspect of the present disclosure provides a bacon product, which contains the bacon and a packaging material sealing the bacon.

Additionally, still another aspect of the present disclosure provides a method for preparing a bacon product, which includes: preparing processed pork by smoking and heating raw pork; preparing bacon by topping spices on the processed pork; and sealing the bacon with a packaging material.

### Advantageous Effects

The bacon product according to the present invention is provided in a state where spices are topped on part of the processed pork. Therefore, the thus-prepared bacon product not only has an improved flavor compared to the conventional one, but also has an advantage in that the problem of deterioration in hygiene due to proliferation of microorganisms during the distribution process can be resolved because there is substantially no E. coli present in the bacon although the bacon sealed within a packaging material is in a state where spices are topped thereon the bacon.

However, the effects of the present disclosure are not limited to those described above, and other effects not described above may be clearly understood by those skilled in the art from the description provided herein below.

### MODE FOR CARRYING OUT THE INVENTION

Hereinafter, the present disclosure will be described in detail.

The present disclosure provides a bacon product and a method for preparing the same.

The bacon product of the present disclosure may be one which contains bacon and a packaging material sealing the bacon, and the bacon may be one in which spices are topped on at least part of the processed pork.

In an embodiment of the present disclosure, the processed pork is prepared by smoking and heating raw pork.

The raw pork may be one which is washed to remove foreign materials or impurities, and in some cases, the raw pork may be aged by low temperature refrigeration, etc. Additionally, the raw pork may be one which is shaped to have a predetermined volume, and thus, the raw pork may be in an amount of 50 g to 2,000 g, or 70 g to 1,500 g, for example, 100 g to 1,000 g.

Additionally, the raw pork may be one which is sterilized to remove microorganisms that remain in the meat itself. The sterilization process may be any sterilization method commonly used in the conventional food industry, such as retort sterilization, hot-water sterilization, steam sterilization, etc. For example, the sterilization process may be performed by heating under a temperature condition of 60° C. to 100° C., or 65° C. to 85° C., for example, 70° C. to 80° C., for 5 minutes or more. Additionally, a flavor may be added to the raw pork and the raw pork may be immersed in a salt solution (or brine) so as to improve meat quality or preservation property, or the salt solution (or brine) may be added to the raw pork and salted by allowing the salt solution (or brine) to penetrate well into the raw pork using a rotary tumbler. In particular, the salt solution (or brine) may contain various kinds of seasonings and spices including salt, sugar, phosphate, etc., and the composition may be variously adjusted by those skilled in the art according to the purpose. It is preferred that the salting process described above be performed for a sufficient time so as to improve the flavor of the raw pork, for example, 1-18 hours or 2-12 hours. However, if the immersion time in the salting solution becomes too long, the meat juice may be leaked out and the flavor may be deteriorated and thus attention is required. The salting may be performed before shaping the raw pork, or may be performed after shaping the raw pork to a desired predetermined volume or mass.

As described above, processed pork is prepared by smoking and heating raw pork. The smoking is a process to expose the raw pork to a smoke generated by burning wood such as oak, chestnut, larch, etc. to be singed. In the smoking process described above, the raw pork is removed of moisture and dried, and at the same time, the components in the smoke penetrate into the pork and thereby improve the flavor. In particular, the smoking process may be performed using sufficiently dried wood in an environment at a temperature of 45° C. to 120° C., or 50° C. to 100° C., for example, 55° C. to 90° C. (e.g., inside of a smoker) for 15 minutes or more, or 30 minutes or more, or 60 minutes or more.

Bacon is prepared by topping spices on at least one surface of the processed pork prepared as described above. The spices may be synthetic or natural materials. When the spices are natural materials, they may be, for example, pepper, garlic, basil, onion, thyme, rosemary, oregano whole, parsley, red pepper, paprika, green onion, pepperonchino, etc. When the spices are natural materials, the spices may be topped on raw pork in a state where the spices are pulverized into an appropriate size, for example, 5-30 mesh, or 10-25 mesh, for example, 15-20 mesh. Microorganisms may be present in the above spices, and the microorganisms may deteriorate the hygiene of bacon (microbial stability) during the distribution process. Accordingly, to remove microorganisms that grow on the spices, especially spices of natural materials, the spices may be topped on the processed pork after performing primary sterilization, before or after the pulverization. The spices which have undergone primary sterilization to be used in the present disclosure may contain heat-resistant bacteria at a concentration of less than 1,000 CFU/g, specifically less than 500 CFU/g, and more specifically less than 10 CFU/g, based on the measurement before performing topping, thereby capable of improving the microbial stability of the finally prepared processed pork. Additionally, it is preferred that the spices be topped in a sufficient amount such that the flavor of the processed pork can be improved, and furthermore, the spices can be visually recognized.

Furthermore, even if the spices are topped after sterilization as described above, the problem of hygiene deterioration due to microorganisms may not be fully resolved, and thus the bacon thus prepared may be sterilized once more time. The sterilization process may be any sterilization method commonly used in the conventional food industry, such as retort sterilization, hot-water sterilization, steam sterilization, etc. For example, the sterilization process may be performed by heating under a temperature condition of 60° C. to 100° C., or 65° C. to 85° C., for example, 70° C. to 80° C., for 5 minutes or more.

In an embodiment of the present disclosure, bacon products are prepared by sealing the bacon prepared as described above using a packaging material. In particular, the bacon may be sealed in a vacuum state so that the bacon can be completely blocked from the outside and tightly sealed.

Furthermore, in an embodiment of the present disclosure, the bacon product in which processed pork is sealed within a packaging material as described above may be “additionally” heated as it is. The additional heating is a process for completing the flavor or texture of the bacon while simultaneously sterilizing microorganisms, which are derived from the spices contained in the bacon of the present disclosure, or microorganisms that may be introduced during the packaging process of the bacon. The additional heating is a hot-water method, and may be performed by heating under a temperature condition of 60° C. to 100° C., or 65° C. to 85° C., for example, 70° C. to 80° C., for 5 minutes or more, or 15 minutes or more, for example, 30 minutes or more.

Additionally, the bacon may be sealed together with a moisture absorbing material. During the additional heating process, a phenomenon of separation of water from bacon may occur, and the deterioration in external quality of bacon or a risk of additional microbial proliferation may be reduced by containing a moisture absorbing material in the bacon product thereby absorbing the water generated due to the phenomenon of water separation. Therefore, the packaging material that seals bacon or the moisture absorbing material which is sealed together with the bacon may be made of a material, which is not deformed or denatured even under the condition of the additional heating, and which does not affect the flavor and hygiene of bacon. For example, the packaging material may be polypropylene, polyethylene, nonwoven fabric, etc. and the moisture absorbing material may be superabsorbent polymer (SAP), sodium polyacrylate, pulp, etc.

The moisture absorbing material to be contained in the bacon product may be, for example, in the form of a sheet, and may have a size of 10-500 mm×10-500 mm or 20-300 mm×20-300 mm, and may be disposed in part of the bacon where spices are not topped. Additionally, the bacon may be sealed in a form having a predetermined volume of raw pork, and each bacon unit may be individually sealed, with the form having a predetermined volume as a unit, and one unit or two or more units of bacon may be contained in one bacon product.

The bacon products of the present disclosure may be provided in a state where bacon in which spices are topped on part of processed pork is individually sealed within a packaging material as a unit or in a state where bacon sliced to have a thickness of less than 0.5 cm forms a group and sealed.

When the bacon products are individually sealed as one unit, the bacon may be provided in an amount of 50-2,000 g, or 70-1,500 g, for example, 100-1,000 g. Additionally, the bacon individually sealed in one unit may be provided in a form having bulkiness, for example, a polygonal shape (e.g., a hexahedron) or cylindrical shape.

In such a case, the bacon individually sealed in one unit may be such that where the edge of the shortest length of the three-dimensional shape (e.g., thickness) may be 0.5 cm or more, 1 cm or more, 3 cm or more, or 5 cm or more. In the case where the bacon is provided in a form having bulkiness without being sliced, the bacon is provided in a state where the texture of the pork itself is maintained, and thus, there is an advantage in that various textures can be realized according to consumer tastes.

Additionally, the bacon individually sealed in one unit may contain, 13-27 wt % or 15-25 wt % (e.g., 17-22 wt %) of fat; 1.5-4 wt % or 2-3.5 wt % (e.g., 2.5-3 wt %) of ash, which is defined by the total weight of inorganics, among 100 wt % of the total mass of the bacon.

Additionally, in the bacon individually sealed in one unit, with regard to the color of the part on which spices are topped, L* in the color coordinate is in a range of 40 to 50 or 41 to 45 (e.g., 43 to 44), a* is in a range of 10 to 15 or 11 to 14 (e.g., 12 to 13.5), b* is in a range of 20 to 33 or 23 to 32 (e.g., 25 to 31), chroma is in a range of 23 to 40 or 25 to 38 (e.g., 27 to 35), and hue-angle is in a range of 20 to 30 or 21 to 29 (e.g., 22 to 28), and the chrominance (ΔE) over the period of before and after the additional heating is in a range of 1 to 37 or 5 to 35 (e.g., 7 to 32).

Furthermore, in the bacon individually sealed in one unit, the hardness measured under the conditions, in which the bacon is penetrated at a speed of 2 mm/sec into a sample at a depth of 10 mm with a 5 g of force as a condition for sample recognition using a cylindrical probe with a diameter of 2 cm and then returned to the original position at a speed of 4 mm/sec, is in a range of 1 N to 12 N or 1.5 N to 10 N; and the chewiness measured under the same conditions is in a range of 1 to 12 or 1.5 to 10. The hardness refers to a degree of hardness of the sample, which means the maximum peak appearing in the first compression process under the above measurement conditions, and the chewiness refers to a property that allows a sample in a solid state to be swallowed. Basically, the above two properties are criteria of texture derived from bacon texture. In particular, by the additional heating performed after the bacon is sealed in a packaging material, the hardness and chewiness may be improved to levels where more excellent sensory functions are exhibited, for example, to levels where hardness is in a range of 4 N to 8N and chewiness is in a range of 2 to 5.

Additionally, in the bacon individually sealed in one unit, the total number of E. coli measured after storing at a temperature of 10-15° C. for 20-36 days immediately after the preparation may be less than 200 CFU/g, less than 100 CFU/g, less than 50 CFU/g, less than 20 CFU/g, or less than 10 CFU/g (e.g., 0 CFU/g). Furthermore, in the bacon individually sealed in one unit, in the bacon individually sealed in one unit, the total number of Coliform bacteria microorganisms (e.g., Escherichia spp., Klebsiella spp., Citrobacter spp., Enterobacter spp. Erwinia spp. Aeromonas spp., Serratia spp., Hafania spp., etc.) measured after storing at a temperature of 10-15° C. for 20-36 days immediately after the preparation may also be less than 200 CFU/g, less than 100 CFU/g, less than 50 CFU/g, less than 20 CFU/g, or less than 10 CFU/g (e.g., 0 CFU/g).

Hereinafter, the present disclosure is described in detail with reference to Examples.

However, the following Examples are illustrative of the present disclosure, and the content of the present disclosure should not be limited by the following Examples.

### Preparation Example 1

About 3-4 kg of pork belly was salted for 12 hours or more, shaped by attaching in series to an iron plate (width: 100 cm, length: 20 cm, height: 5.5 cm) in the form of a cuboid with a total of 10-13 kg, put into a smoker and smoked and heated under the temperature condition of 55° C. to 90° C. for 180 minutes with a smoke generated by burning oak to prepare processed pork. The processed pork was cooled and then sterilized pepper, which was pulverized into a size of about 20 mesh, was sufficiently toppled on one surface of the processed pork and thereby bacon was prepared.

The thus-prepared bacon was cut into a unit of 350 g, and the resulting bacon was completely sealed with PE as one unit, and thereby a thick bacon product topped with pepper, onto which no additional heating was applied, was prepared.

### Preparation Example 2

The thick bacon product topped with pepper prepared in Preparation Example 1 was subjected to additional heating by the hot-water method under the temperature condition of 70° C. to 80° C. for 30 minutes in a state completely sealed with PE, and thereby a thick bacon product topped with pepper, onto which additional heating was applied.

### Preparation Example 3

A thick bacon product topped with garlic/basil, onto which no additional heating was applied, was prepared in the same manner as in Preparation Example 1 except that sterilized garlic and basil, instead of pepper, pulverized to a size of about 20 mesh were used as spices.

### Preparation Example 4

A thick bacon product topped with garlic/basil, onto which additional heating was applied, was prepared by subjecting the thick bacon product, which is topped with garlic/basil and was prepared in Preparation Example 1, to additional heating by the hot-water method under the temperature condition of 70° C. to 80° C. for 30 minutes.

### Experimental Example 1

Results of Analysis of Microorganism in Bacon

The thick bacon products prepared in Preparation Examples 1 to 4 were stored at a temperature of 15° C. for 36 days immediately after the preparation, and the presence/absence of E. coli was examined by the EC culture method after separating the bacon from the packaging material in each thick bacon product, and the presence/absence and total number of Coliform group microorganisms were examined by the desoxycholate lactose agar method and 3M Petrifilm™ Coliform count plates. The results are shown in Table 1 below.

TABLE 1

| | | Total Number of Coliform |
|---|---|---|
| Preparation | Total Number | group microorganisms |
| Example | of E. coli | (CFU/g) |
| 1 | Negative | 30-150 |
| 2 | Negative | Negative |
| 3 | Negative | 20-160 |
| 4 | Negative | Negative |

### Experimental Example 2

Confirmation of Chromaticity of Bacon

The bacon in each of the thick bacon products prepared in Preparation Examples 1 to 4 was separated from the packaging material, and the spices topped on the surface of the bacon were removed. The resulting bacon was subjected to a total of 5 measurements with regard to L*(brightness), a*(redness), b*(yellowness), chroma, hue-angle, and ΔE(chrominance) under the same conditions using a colorimeter (JC 801, Color techno system Co, Japan), and the average values of the measurement results are each shown in Table 2 below. The values of the standard base plate were L*=93.73, a*=−0.12, and b*=0.11.

TABLE 2

| | | | | | | ΔE Before |
|---|---|---|---|---|---|---|
| | | | | | | and After |
| | | | | | | Additional |
| | L* | a* | b* | Chroma | Hue-Angle | Heating |
| Preparation | (Standard | (Standard | (Standard | (Standard | (Standard | (Standard |
| Example | Deviation) | Deviation) | Deviation) | Deviation) | Deviation) | Deviation) |
| 1 | 52.09 | 13.38 | 27.91 | 31.00 | 25.67 | 9.75 |
| | (3.39) | (1.62) | (1.91) | (1.53) | (3.73) | (3.74) |
| 2 | 43.39 | 12.98 | 25.23 | 28.42 | 27.48 | |
| | (3.79) | (0.85) | (3.25) | (2.85) | (3.47) | |
| 3 | 69.32 | 7.02 | 18.72 | 20.01 | 20.56 | 29.13 |
| | (2.19) | (1.22) | (2.03) | (2.14) | (2.82) | (20.8) |
| 4 | 43.46 | 13.06 | 30.55 | 33.24 | 23.14 | |
| | (1.77) | (0.93) | (1.29) | (1.41) | (1.24) | |

### Experimental Example 3

Analysis of Physical Properties of Processed Pork

The bacon in each of the thick bacon products prepared in Preparation Examples 1 to 4 was separated from the packaging material, and the physical properties with regard to hardness, cohesiveness, springiness, chewiness, and gumminess were measured using a physical property analyzer, TA-XT Plus (Texture Technologies Co., Ltd., UK) were examined. A total of 20 measurements were made under the same conditions and the average values of the measurement results are each shown in Table 3 below.

The physical property analyzer mimics the behavior of a person's chewing twice in the mouth. The cylinder metal probe of the physical property analyzer vertically descends from a pre-set distance to a food sample at a controlled rate. Then, the probe again ascends to the extent of a pre-set distance and descends again for a second chewing. A force perceiving device and a transformer recognize the force applied to a sample to be measured and send the data (force value, operation time, and probe travel distance) to a computer. The definitions of terms associated with the physical property measurement and the conditions for physical property measurement are as follows:

<Definition of Terms Associated with Physical Property Measurement>

(1) Hardness (N): the force required to reach a predetermined deformation, which is the maximum force in the first chewing

(2) Cohesiveness: the degree of an internal binding required to form the body of food

(3) Springiness: the speed at which the deformedmaterial returns to the initial state before it is deformed after removal of the deforming force

(4) Chewiness: the number of chewing steps required for food to be swallowed (=gumminess*springiness)

(5) Gumminess (N): the force required to decompose semi-solid food (the property that makes a sample in a semi-solid state to a state to be swallowed) (=cohesiveness*hardness)

<Conditions for Physical Property Measurement>

Probe: a cylindrical shape where the diameter is 2.5 cm×2.0 cm;

the speed at which the probe descends to a sample (pre-test speed): 2.0 mm/sec;

the speed at which the probe penetrates a sample after the probe touches the surface of the sample (test speed): 2.0 mm/sec;

the speed at which the probe returns to the original position after penetrating the sample (post-test speed): 4.0 mm/sec;

the distance that the probe recognizes a surface of the sample and penetrates through the sample: 10.0 mm;

the conditions for the probe to recognize the sample (trigger type): force; 5.0 g.

TABLE 3

| | Hardness (N) | Cohesiveness | Springiness | Chewiness | Gumminess (N) |
|---|---|---|---|---|---|
| Preparation | (Standard | (Standard | (Standard | (Standard | (Standard |
| Example | Deviation) | Deviation) | Deviation) | Deviation) | Deviation) |
| 1 | 8.909 | 0.587 | 1.003 | 5.224 | 5.229 |
| | (1.131) | (0.038) | (0.170) | (1.004) | (0.764) |
| 2 | 5.793 | 0.554 | 1.148 | 3.702 | 3.203 |
| | (1.648) | (0.082) | (0.360) | (1.812) | (0.970) |
| 3 | 8.911 | 0.523 | 1.555 | 7.297 | 4.646 |
| | (1.378) | (0.035) | (0.493) | (2.826) | (0.655) |
| 4 | 6.402 | 0.556 | 0.968 | 3.436 | 3.613 |
| | (2.038) | (0.063) | (0.090) | (1.137) | (1.256) |

### Experimental Example 4

Analysis of Bacon Components

The bacon in each of the thick bacon products prepared in Preparation Examples 1 to 4 was separated from the packaging material, and the contents of moisture, fat, protein, and ash inside the bacon were measured. More specifically, according to the AOAC method (1990), moisture was quantified by the method of drying by heating at atmospheric pressure; protein by the semi-micro Kjeldahl method; fat by the Soxhlet method; and ash by the dry asking method. The results are shown in Table 4 below.

TABLE 4

| | Moisture | Fat | Protein | Ash |
|---|---|---|---|---|
| Preparation | Content | Content | Content | Content |
| Example | (%) | (%) | (%) | (%) |
| 1 | 59.2 | 2.92 | 17.1 | 15.2 |
| 2 | 61.1 | 17.5 | 16.7 | 2.6 |
| 3 | 61.5 | 2.72 | 15.9 | 16.5 |
| 4 | 57.2 | 21.5 | 15.8 | 2.84 |

Although the preferred preparation examples of the present disclosure have been illustrated above, the scope of the present disclosure is not limited to the specific preparation examples as described above, and those skilled in the art will be able to make appropriate modifications and variations within the scope of the present disclosure described in the appended claims.

1. Bacon comprising processed pork and spices topped on the processed pork, wherein the total number of E. coli in the bacon measured after storing at a temperature of 15° C. for 36 days immediately after the preparation is less than 200 CFU/g.

2. The bacon of claim 1, wherein the fat content of the bacon with respect to 100 wt % of the total mass of the bacon is in a range of 13-27 wt %.

3. The bacon of claim 1, wherein the ash content of the bacon with respect to 100 wt % of the total mass of the bacon is in a range of 1.5-4 wt %.

4. The bacon of claim 1, wherein the spices comprise at least one selected from the group consisting of pepper, garlic, and basil.

5. The bacon of claim 1, wherein the total number of E. coli in the bacon measured after storing at a temperature of 15° C. for 36 days immediately after the preparation is 0 CFU/g.

6. The bacon of claim 1, wherein the total number of Coliform group microorganisms in the bacon measured after storing at a temperature of 15° C. for 36 days immediately after the preparation is less than 20 CFU/g.

7. The bacon of claim 1, wherein, with regard to the color of at least one surface of the processed pork on which spices are topped, the L* in the color coordinate is in a range of 40 to 50, the a* is in a range of 10 to 15, the b* is in a range of 20 to 33, the chroma is in a range of 23 to 40, and the hue-angle is in a range of 20 to 30.

8. The bacon of claim 1, wherein the hardness of the bacon is in a range of 1 N to 12 N.

9. The bacon of claim 1, wherein the chewiness of the bacon measured under the conditions, in which the bacon is penetrated at a speed of 2 mm/sec into a sample at a depth of 10 mm with a 5 g of force as a condition for sample recognition using a cylindrical probe with a diameter of 2 cm and then returned to the original position at a speed of 4 mm/sec, is in a range of 1 to 12.

10. A bacon product, comprising the bacon of claim 1 and a packaging material sealing the bacon.

11. The bacon product of claim 10, further comprising at least one moisture absorbing material which is sealed within the packaging material along with the bacon.

12. The bacon product of claim 11, wherein the moisture absorbing material is disposed in a part where the spices of the bacon are not topped.

13. A method for preparing a bacon product, comprising:
preparing processed pork by smoking and heating raw pork;
preparing bacon by topping spices on the processed pork; and
sealing the bacon with a packaging material.

14. The method of claim 13, further heating the bacon product in a state where the bacon is sealed with the packaging material.

15. The method of claim 13, wherein the total number of E. coli in the bacon sealed with the packaging material measured after storing at a temperature of 15° C. for 36 days immediately after the preparation is less than 200 CFU/g.

16. The method of claim 13, wherein the raw pork is salted.

17. The method of claim 13, further comprising sterilizing the bacon before sealing the bacon with a packaging material.

18. The method of claim 14, the further heating is performed at a temperature of 60° C. to 100° C.

19. The method of claim 14, wherein, over the period of before and after the further heating, the chrominance (ΔE) of the color according to the color coordinate of at least one surface of the bacon on which spices are topped is in a range of 1 to 37.

20. The method of claim 14, wherein the total number of E. coli in the bacon sealed with the packaging material measured after storing at a temperature of 15° C. for 36 days immediately after the preparation is less than 200 CFU/g.
